(19) United States
(12) Patent Application Publication
(10) Pub. No.: US 2007/0193674 A1
(43) Pub. Date: Aug. 23, 2007

(54) FABRICS AND THE MANUFACTURE OF FABRICS

(76) Inventor: Donald Henry HOURAHANE, Horizon (ZA)

Correspondence Address: DALINA LAW GROUP, P.C., 7910 IVANHOE AVE. #325, LA JOLLA, CA, 92037, US

(21) Appl. No.: 11/675,255

(22) Filed: Feb. 15, 2007

(30) Foreign Application Priority Data
Feb. 15, 2006 (ZA) 2006/01348

(51) Int. Cl. B29C 65/06

(52) U.S. Cl. 156/73.5

(57) ABSTRACT

A fabric is disclosed which comprises crossing yarns (36, 38), which can be the warp and the weft of a woven fabric, and in which at their crossing points, or nodes, the yarns are welded to one another. Apparatus for welding the crossing yarns by heat and by pressure is also disclosed. The apparatus in one form comprises a head (38) which feeds out a weft yarn (40) as the head crosses a number of warp yarns (36). An acoustic horn (42) and anvil (30) are provided for welding the nodes together immediately after the weft (38) has been fed out. The anvil is serrated to provide sloping supporting surfaces (32) and buttress surfaces (34) against which the yarn (36) is pressed by the yarns (38) as the horn passes over each yarn (36).

### BACKGROUND OF THE INVENTION

1. Field of the Invention

THIS INVENTION relates to fabrics and to the manufacture of fabrics.

2. Description of the Related Art

Weaving as an art and then as an industry has been known since the beginning of recorded history. The machinery used has changed in sophistication and in its speed of production but the basic concept remains the same. One group of warp yarns is raised above another group of warp yarns and a shuttle or a rapier carrying the weft yarn passes between the two groups. The upper group is then lowered and the lower group raised and the shuttle or rapier returns through the newly created gap. Thus each weft yarn passes above some warp yarns and below others. If one warp yarn is above a particular weft yarn, the warp yarns on either side of it are normally below that particular weft yarn. The places where yarns intersect will hereinafter for convenience be referred to as “nodes”.

Knitting is another widely used method of producing fabric. In flat bed knitting a third yarn is used to tie the warp and weft yarns to one another. In other respects knitting is essentially the same as weaving, the yarns crossing one another at “nodes”.

The present invention requires that yarns cross one another, and whether this is achieved by weaving, knitting or otherwise is not of importance. It is the creation of a multitude of “nodes” that is of significance. At each “node”, at least two yarns cross one another.

Significant interest is now being shown in the technical field to which the general terms “textile concrete” and “textile reinforced concrete” are being applied.

Conventionally concrete structures are reinforced by steel bars, and the concrete has to be thick enough to provide cover for the steel. The shape of the reinforcing depends on the shape of the component. A floor, for example, is usually reinforced by a grid of bars embedded in it. As another example a column is reinforced by vertically extending bars tied together to form a vertically extending box.

There has been great resistance to the concept that steel reinforcing can, at least for some uses, successfully be replaced by a textile fabric.

In my PCT application No. PCT/US97/00362 (published on 9 Jun. 1997 as WO 97/26395) I disclose a yarn which can be woven into the form of a textile fabric which can be used as reinforcing in concrete. Experimental work has shown that by working layers of such fabric into wet concrete it is possible to produce thin lightweight panels which have sufficient strength to withstand substantial loadings. Such panels, when supported at the ends and loaded in the middle, bend as they are ductile. Micro-cracks form as a load is applied. When the load is removed, the energy that has been stored in the layers of textile fabric pulls the panel back into shape. This closes the micro-cracks. The closed cracks can be wetted and they then self heal. If the textile fabric is manufactured using glass fibres, carbon fibres, “kevlar” or gel-spun high density polyethylene, the characteristics of the resultant reinforced concrete product are similar to those of steel reinforced concrete.

The yarn disclosed in WO 97/26395 comprises a core around which is spun a sheath of staple fibres. Such a yarn is referred to as a friction spun yarn or a Dref yarn. In accordance with my earlier invention, at intervals along the length of the yarn, the sheath is welded to the core. This prevents slippage between the core and sheath. The ability to resist slippage increases in importance as the strength of the filaments which constitute the core increases. The concrete deflects as load is applied and this results in a restoring force being stored in the fabric.

The object of the present invention is to provide a new method of manufacturing a textile fabric. The textile fabric produced can be used for all the purposes that woven fabrics or knitted fabric are currently used but is particularly useful for incorporation into concrete as reinforcing because its characteristics are an improvement on those manufactured using the yarn disclosed in WO 97/26395.

### BRIEF DESCRIPTION OF THE INVENTION

According to a first aspect of the present invention there is provided a method of manufacturing a textile fabric which comprises arranging yarns which are of materials that can be welded to one another in a pattern which includes a multitude of nodes where yarns cross one another, and welding the crossing yarns to one another at said nodes.

The nodes can be formed by weaving, and welding can take place subsequent to insertion of the weft yarns. In this form it is possible to weld the warp and weft yarns together along the selvages thereby to create welded selvages, displace the unbonded warp and weft yarns to a welding zone, and weld them together at the nodes.

Knitted fabrics can be passed between an anvil and an ultrasonic horn so that welding takes place at the nodes where yarns cross. It is also possible, as an alternative to weaving and knitting, to lay-up a plurality of longitudinal yarns at the requisite spacing, thereafter to lay-up transverse yarns across the longitudinal yarns, and finally to weld the longitudinal and transverse yarns to one another.

The means for laying-up the transverse yarns and thereafter welding the transverse yarns to the longitudinal yarns can comprise a head and an ultrasonic horn, the head feeding out the transverse yarn and the ultrasonic horn thereafter pressing the crossing yarns against one another for the purposes of welding them.

The mass of the ultrasonic horn, plus additional weights if required, presses the yarns together.

Where the fabric is a woven one, welding can take place as the weft yarn is inserted by a reciprocating head, there being welding means carried by the head. The welding means can comprise one or more ultrasonic horns.

In one embodiment of the invention one or more welding means are provided which move over a plotting table on which the crossing yarns lie, the movement of the or each welding means and the times at which the or each welding means is activated being computer controlled to obtain a predetermined pattern of welded intersections.

According to a second aspect of the present invention there is provided a method of producing a textile fabric which comprises advancing a plurality of longitudinally extending yarns, displacing a head transversely of the longitudinally extending yarns and feeding out one or more transverse yarns from the head, and welding the transverse yarn to the longitudinally extending yarns where the yarns intersect.

In the preferred embodiment the yarns are welded together ultrasonically at their intersections.

The method preferably comprises feeding out one or more transverse yarns from the head, ultrasonically welding the intersecting yarns as the transverse yarn is fed out from the head, advancing the longitudinal yarns after the head has completed a transverse pass, and causing the head to perform a pass in the reverse direction thereby to lay down a further transverse yarn.

There can be a second head on the side of the longitudinal yarns opposed to the first head, the heads being displaced transversely whereby some, preferably alternate, transverse yarns are on opposite sides of the longitudinal yarns.

The longitudinal yarns can extend horizontally or vertically.

According to a third aspect of the present invention there is provided apparatus for producing a textile fabric which apparatus comprises means for advancing a plurality of longitudinal yarns, a head for feeding out one or more transverse yarns as the head moves transversely of the longitudinal yarns, and means for welding the transversely extending yarns to the longitudinally extending yarns where the yarns intersect.

The apparatus preferably includes means for advancing the longitudinal yarns after each pass of the head.

A second head and a second welding means can be provided on the opposite side of the longitudinal yarns to the first head and welding means. This enables transverse yarns to be provided on opposite sides of the longitudinal yarns.

The or each welding means can comprise an ultrasonic horn. In the preferred form there are two ultrasonic horns positioned so that, regardless of the direction of travel of the head, there is always a horn which trails the location at which the transverse yarn(s) is or are being fed out from the head.

The apparatus can further include a plate with a serrated surface, the serrations providing inclined supporting surfaces for longitudinally extending yarns and more steeply inclined buttress surfaces, said head and the welding means moving transversely with respect to said serrations, and the welding means exerting a downward force on the transversely extending yarns to press them against the longitudinally extending yarns which are in turn forced against said buttress surfaces.

There can be notches in the apices of the serrations for receiving the transverse yarns.

According to a fourth aspect of the present invention there is provided a method of manufacturing a textile fabric using a yarn comprising a core and a sheath of staple fibres through which the core passes, the method being characterised by the step of welding the fabric at a multitude of locations where yarns intersect one another thereby to inhibit displacement of the sheath with respect to the core.

Welding can be by the application of heat and pressure. The heat can be derived from electrical heating elements and the pressure can be applied mechanically. It is preferred, however, that welding be achieved ultrasonically between an ultrasonic horn and an anvil. The mass of the horn, to which weights can be added if necessary, presses the intersecting yarns together.

When electrical energy at a frequency of, say, 20 or 40 khz is applied to an ultrasonic horn, to excite the horn at its natural frequency, the horn changes shape and “hammers” at high frequency on the crossing yarns. Heat is generated which cannot, because of the poor conductivity of the material of both the sheath and the core, flow away and has to be removed by an air stream. The air stream also cools the horn. The localized rise in temperature occurs in micro-seconds and causes the crossing yarns to weld to one another. The welds attach the sheaths to the cores where welding take place so that movement of the sheaths with respect to the cores is inhibited. “Hammering” takes place for a period of time sufficient to allow welding to take place.

If the core is not of a weldable thermoplastic material, it is possible to include a cross linkable adhesive in the form of fibres incorporated into the sheath or to cover the core with a coating of cross-linkable adhesive. Upon the application of heat and pressure, the fibres soften and exude the bonding adhesive onto the core. The fibres of the sheath bond to one another and are themselves bonded to the core by the adhesive, which cross links permanently to form the weld. Examples of materials that can be used to constitute non-thermoplastic cores are A-R glass, E-G glass, carbon filaments and fine stainless steel wire.

In accordance with a specific embodiment of the invention a sheet of synthetic plastic material is juxtaposed to one side of the textile fabric and the sheet and fabric are welded together thereto thereby to provide, depending on the nature of the sheet material, a liquid or gas proof composite material. Material of this nature can be used, for example, in the production of pond or pipe linings, or the lining of chemical storage tanks.

The method can also comprise sandwiching a layer of sheet synthetic plastics material between two layers of textile fabric. It is possible to apply a layer of cement mortar to each layer of fabric so that the layers of fabric are embedded in the mortar. The layer of sheet synthetic plastics material can constitute a separator between different types of matrix. For example, one layer of textile fabric can be embedded in a concrete matrix and the other can be embedded in a layer of gypsum plaster or a layer of synthetic resin.

It is also possible to embed the sandwich in rubber or synthetic plastic material matrices. The fabric of the present invention can be embedded, as a single layer or multiple layers, in rubber or synthetic resins.

### BRIEF DESCRIPTION OF THE DRAWINGS

For a better understanding of the present invention, and to show how the same may be carried into effect, reference will now be made, by way of example, to the accompanying drawings in which:

FIG. 1 is a diagrammatic side elevation of a machine for producing fabric in accordance with the present invention;

FIG. 2 illustrates a fabric in accordance with the present invention; and

FIG. 3 diagrammatically illustrates a further machine for producing a fabric.

### DETAILED DESCRIPTION OF THE DRAWINGS

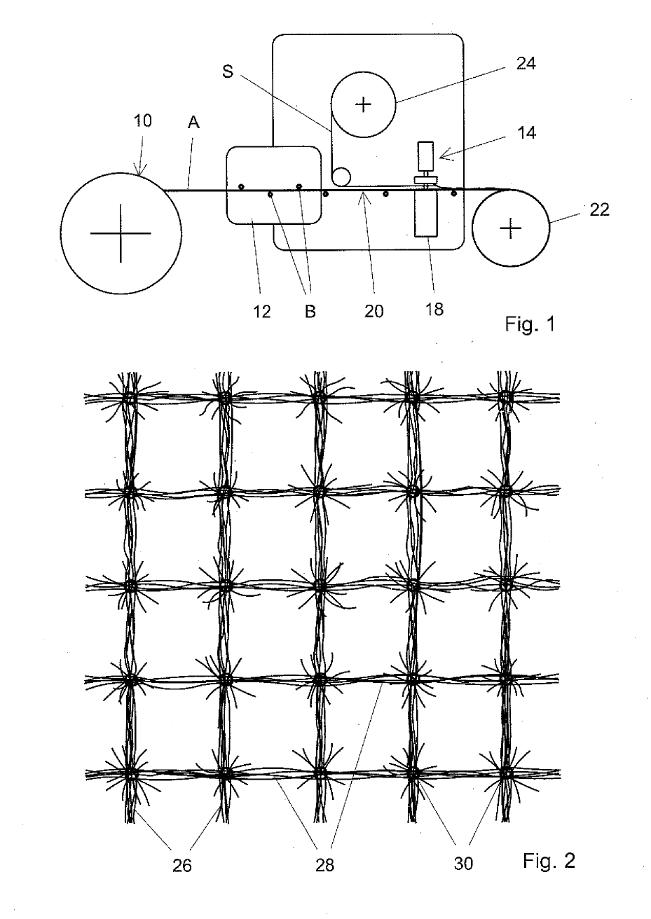

Referring firstly to FIG. 1, reference numeral 10 designates a warp beam which carries a multitude of warp yarns A. These are fed off the beam 10 into the zone 12 where knitting or weaving takes place. If it is weaving that takes place at the zone 12, then it is here that the weft yarns B are inserted. The warp beam can be replaced by a plurality of creels.

Reference 14 designates an ultrasonic welding unit which is usually referred to as an ultrasonic horn. The unit 14 comprises the horn 16 itself and an anvil 18. The woven or knitted fabric, designated 20, passes between the horn 16 and the anvil 18 and is wound onto a take-up spindle 22. Between the horn 16 and the anvil 18, the nodes where yarns cross one another are welded.

To provide a fabric which is waterproof, a web of, for example, synthetic plastic material s is fed from a source reel 24 and between the horn 16 and the anvil 18. The material of the web is compatible with the material forming the warp and weft yarns so that, at the node points, the web is welded to the yarns. The web can also be of a non-woven fabric thereby to provide a composite material in which the non-woven fabric is reinforced by the welded mesh.

It will be understood that the yarns employed must be capable of welding to one another upon the application of heat and pressure. It is not necessary that all the fibres constituting a yarn be of a type that will weld to all the fibres of a crossing yarn. It is sufficient if a proportion of the fibres will weld as the fibres which do weld trap those which are of a material that will not weld.

FIG. 2 illustrates a fabric in accordance with the present invention and which comprises Dref yarns arranged as longitudinal yarns 26 and transverse yarns 28 which intersect and which are welded together at the crossing points or nodes 30.

It will be understood that where, in the above, reference is made to a yarn, such yarn could be a plurality of yarns or a flat ribbon. The ribbon can be entirely of weldable material or can include a proportion of weldable material. The yarns can all be weldable, or a proportion of the yarns can be weldable.

As an example, satisfactory welds can be obtained if 30% of the yarns weld to one another when heat and pressure are applied.

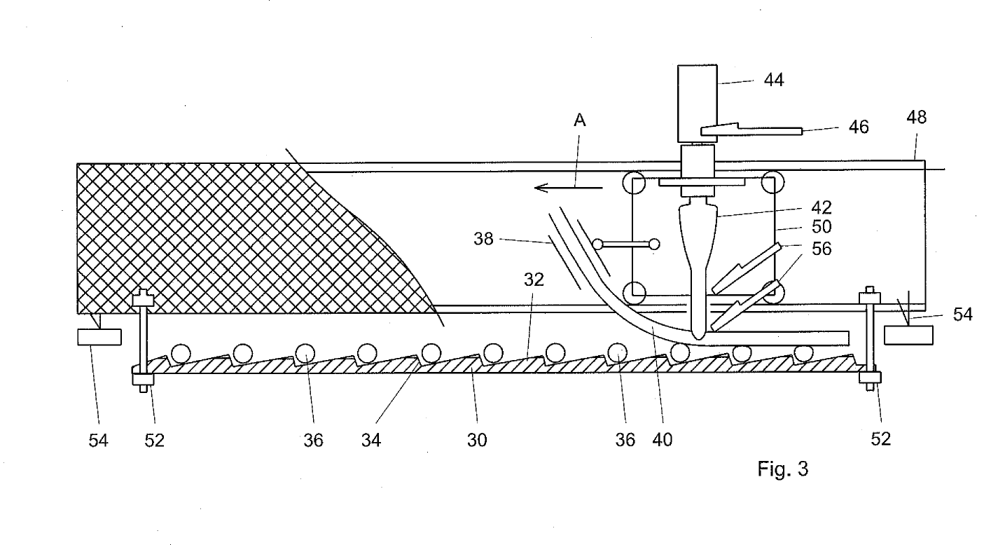

In FIG. 3 the size of the yarns has to be exaggerated for illustrative purposes. FIG. 3 illustrates an anvil 30 which has a serrated top surface. The serrations provide a set of sloping supporting surfaces 32 and a set of buttress surfaces 34. Notches are formed in the apices of the serrations.

A longitudinal yarn 36 (or a group of longitudinal yarns) is guided onto each surface 32 by means of a comb (not shown) from creels on a creel stand. The comb spreads the longitudinal yarns 36 so that one yarn, or if desired a group of yarns, is guided onto each surface 32. The yarns 36 are pulled by a winder (not shown) into the plane of the paper, that is, away from the viewpoint from which FIG. 3 is viewed.

A transverse yarn feed head 38 moves in the transverse direction, as indicated by the arrow A, feeding out a single yarn or a plurality of yarns 40. Immediately behind the head, in the direction of travel, there is an ultrasonic horn 42. The horn, in use of the apparatus, remains on at all times.

An air cylinder 44 carried the horn 42, there being an air inlet 46 to the lower end of the cylinder 44. The mass of the horn, plus additional weights if required, provides the downward force that is required. The air cylinder 44, when activated, lifts the horn 42 away from the anvil 30.

A transverse framework 48 is provided above the anvil 30. A wheeled carriage 50 is supported by the framework 48 and is reciprocated in the transverse direction by a drive means such as a belt or chain. The head 38 and horn 42 are mounted on the carriage 50.

Reference numerals 52 denote levelling devices such as screws which can be used to bring the anvil 30 and the framework 48 into a parallel relationship so that the distance between the crests of the serrations and the horn 42 is constant across the width of the anvil.

Further levelling devices 54 are provided for adjusting the position of the framework 48, and hence that of the anvil 30, with respect to the bed of the apparatus.

The horn 42 is shown as being positioned at right angles to the yarn 36. It is, however, possible for the horn to be skew to the yarn 36 so that some part of the horn is at all times welding two intersecting yarns.

The horn 42 presses down on the yarns 40 and the yarns 40 press down on the yarns 36. The yarns 36 slide down the surfaces 32 until they encounter the adjacent buttress surfaces 34. This ensures that the longitudinal yarns 36 are evenly spaced.

As the horn approaches each buttress surface 34 it welds the crossing yarns together. The dimensions of the yarns 36 are smaller than shown, and the yarns 40 enter and are located by the notches in the apices of the serrations.

Upon the head 38 and horn 42 reaching the end of their travel to the left, the head ceases to feed out yarns 40 and the yarns 40 already fed out are cut off. The head 38 and the horn 42 are lifted by the cylinder 44, the head and horn then making an inoperative pass to return them to the right hand end. The loose, cut ends of the yarns 40 are then welded to the outside i.e. extreme right hand yarns 36 and subsequent movement to the left of the carriage 50 results in yarns 40 being fed out again. The horn 42 is activated so that more welds are produced as the horn 42 travels left.

Alternatively, if only one or two yarns 40 are being used, the structure comprising the head 38, the ultrasonic horn 42 and the cylinder 44 can turn through 180 degrees at the end of its travel to the left and then make an operative return pass, yarns 40 being fed out and welded to the yarns 36 during this pass. At the end of the return pass, the structure rotates 180 degrees in the other direction.

As another alternative there can be a single head 38 with a horn 42 each side thereof. That horn which is behind the head in the direction of travel of the head is activated and the other is inoperative.

Air is blown, as shown by the arrows 56, against the horn for cooling purposes.

1. A method of manufacturing a textile fabric which comprises arranging yarns which are of materials that can be welded to one another in a pattern which includes a multitude of nodes where yarns cross one another, and welding the crossing yarns to one another at said nodes.

2. A method as claimed in claim 1, wherein the fabric is a woven one comprising warp yarns and weft yarns and welding takes place subsequent to insertion of the weft yarns.

3. A method as claimed in claim 2 and including the step of welding the warp and weft yarns together along the selvages thereby to create welded selvages, displacing the unbonded warp and weft yarns to a welding zone, and welding them together at the nodes.

4. A method as claimed in claim 1, wherein the fabric is a knitted one and is passed between an anvil and an ultrasonic horn so that welding takes place at the nodes where yarns cross.

5. A method as claimed in claim 1 and comprising laying-up a plurality of longitudinal yarns at the requisite spacing, thereafter laying-up transverse yarns across the longitudinal yarns, and welding the longitudinal and transverse yarns to one another at the nodes where they intersect.

6. A method as claimed in claim 5 and comprising laying-up the longitudinal yams, advancing a head transversely and feeding out one or more transverse yarns from the advancing head, and using an ultrasonic horn to press the intersecting yarns against one another and weld them together.

7. A method as claimed in claim 5 and comprising using one or more welding means which move over a plotting table on which the intersecting yarns lie, the movement of the or each welding means and the times at which the or each welding means is activated being computer controlled to obtain a predetermined pattern of welded intersections.

8. A method as claimed in claim 1, wherein the fabric is a woven one and welding takes place as the weft yarn is inserted by a reciprocating head, there being welding means carried by the head.

9. A method as claimed in claim 8, wherein said welding means comprises one or more ultrasonic horns.

10. A method of producing a textile fabric which comprises advancing a plurality of longitudinally extending yarns, displacing a head transversely of the longitudinally extending yarns and feeding out a transverse yarn from the head, and welding the transverse yarn to the longitudinally extending yarns where the yarns intersect.

11. A method as claimed in claim 10, wherein the yarns are welded ultrasonically at their intersections.

12. A method as claimed in claim 11 and comprising feeding out one or more transverse yarns from the head, ultrasonically welding the intersecting yarns as the transverse yarn is fed out from the head, advancing the longitudinal yarns after the head has completed a transverse pass, and causing the head to perform a pass in the reverse direction thereby to lay down a further transverse yarn.

13. A method as claimed in claim 12, wherein there is a second head on the side of the longitudinal yarns opposed to the first head, the method comprising displacing said heads transversely whereby there are transverse yarns on opposite sides of the longitudinal yarns.

14. Apparatus for producing a textile fabric which apparatus comprises means for advancing a plurality of longitudinal yarns, a head for feeding out one or more transverse yarns, means for displacing the head transversely of the longitudinal yarns, and means for welding the transversely extending yarns to the longitudinally extending yarns where the yarns intersect.

15. Apparatus as claimed in claim 14 and including means for advancing the longitudinal yarns after each pass of the head.

16. Apparatus as claimed in claim 14 and including a second head and a second welding means on the opposite side of the intersecting yarns to the first head and welding means.

17. Apparatus as claimed in claim 14, wherein the or each welding means comprises an ultrasonic horn.

18. Apparatus as claimed in claim 17, wherein each welding means comprises two ultrasonic horns which are positioned so that there is always a horn which trails the location at which the transverse yarn(s) is or are being fed out from the head.

19. Apparatus as claimed in claim 14, and including a plate with a serrated surface, the serrations providing inclined supporting surfaces for longitudinally extending yarns and more steeply inclined buttress surfaces, said head and the welding means moving transversely with respect to said serrations, and the welding means exerting a downward force on the transversely extending yarns to press them against the longitudinally extending yarns which are in turn forced against said buttress surfaces.

20. Apparatus as claimed in claim 19 and including notches in the apices of the serrations for receiving the transverse yarns.

21. A method of manufacturing a textile fabric using a yarn comprising a core and a sheath of staple fibres through which the core passes, the method being characterised by the step of welding the fabric at a multitude of locations where yarns intersect one another thereby to inhibit displacement of the sheath with respect to the core.

22. A method as claimed in claim 21, wherein heat and pressure are applied to weld the yarns where they intersect.

23. A method as claimed in claim 22, wherein welding is achieved by means of an ultrasonic horn and an anvil.

24. A method as claimed in claim 21 and including the step of incorporating a cross linkable bonding adhesive, the adhesive being in the form of fibres incorporated into the sheath or in the form of a coating on the core.

25. A method as claimed in claim 1 and comprising juxtaposing a sheet of synthetic plastic material to one side of the textile fabric and welding the sheet and the fabric together.

26. A method according to claim 25 and comprising sandwiching a layer of sheet synthetic plastics material between two layers of textile fabric.

27. A method as claimed in claim 26 and including the step of applying a layer of cement mortar to each layer of fabric so that the layers of fabric are embedded in the mortar.

28. A method as claimed in claim 26 and including the step of applying one type of matrix to one of said layers and another type of matrix to the other of said layers.
